(19) United States
(12) Patent Application Publication
(10) Pub. No.: US 2010/0182191 A1
(43) Pub. Date: Jul. 22, 2010

(54) RECEIVER EQUALISATION

(75) Inventor: James Alexander Hill, Hampshire (GB)

Correspondence Address: PILLSBURY WINTHROP SHAW PITTMAN, LLP, P.O. BOX 10500, MCLEAN, VA, 22102, US

(73) Assignee: BAE SYSTEMS plc, London (GB)

(21) Appl. No.: 12/301,539

(22) PCT Filed: Oct. 7, 2008
(86) PCT No.: PCT/GB2008/050916

§ 371 Date: Dec. 1, 2008

(30) Foreign Application Priority Data
Oct. 12, 2007 (EP) 07270059.4
Oct. 12, 2007 (GB) 0719941.7

(51) Int. Cl. G01S 7/40

(52) U.S. Cl. 342/174

(57) ABSTRACT

The present invention relates to a method of receiver equalisation. More specifically, the present invention relates to a method of receiver equalisation in multi-function radar apparatus. The present invention provides a method of receiver equalisation comprising passing a known RF pulse through a receiver array; comparing an output of the receiver array with a reference output of that array; and calculating a correction waveform to be applied to the output of the array antenna at all times required during normal radar operation.

The present invention relates to a method of receiver equalisation. More specifically, the present invention relates to a method of receiver equalisation in multi-function radar apparatus.

The performance of adaptive beam forming relies on the knowledge of the characteristics of the sub-arrays from which the beams are formed. It is therefore essential that the phase, gain and delay parameters of each sub-array are well known.

The present invention provides a method of receiver equalisation comprising the steps of: passing a known RF pulse through an array of receivers; comparing an output of the array with a reference output of the array; and calculating a correction waveform to be applied to the output of the array antenna.

Specific embodiments of the invention will now be described, by way of example only and with reference to the accompanying drawings that have like reference numerals, wherein:

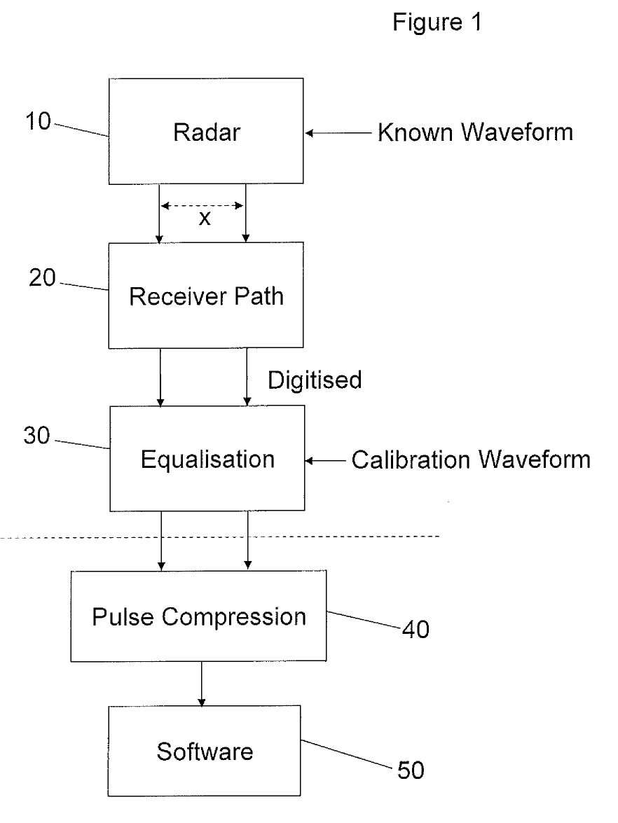

FIG. 1 is a diagram showing the process of the preferred embodiment of the present invention; and

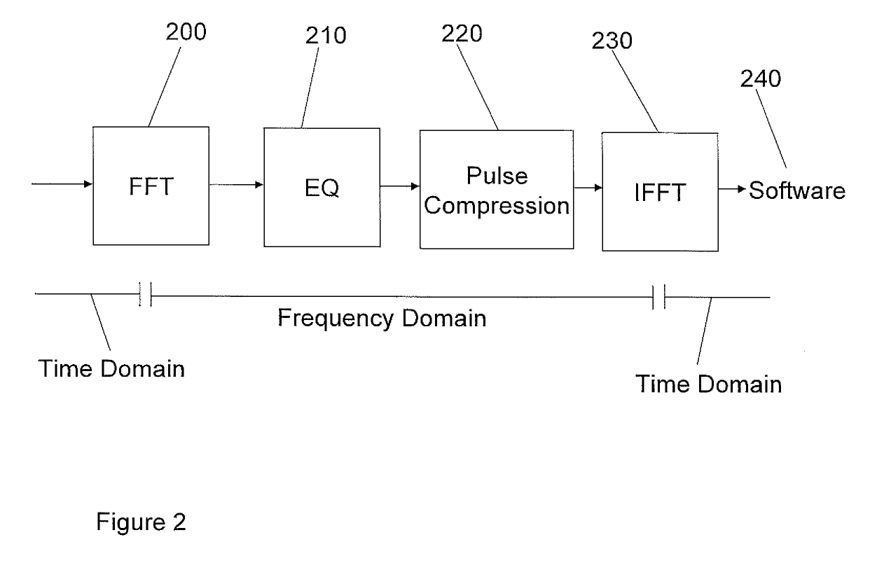

FIG. 2 is a diagram showing the movement of the process of the preferred embodiment of the present invention between the time and frequency domains.

The specific embodiment will now be described with reference to FIGS. 1 to 2:

To aid the knowledge of the phase, gain and delay parameters of each subarray, each sub-array receiver is matched to a set of standard predetermined characteristics. This is done by an on-line equalisation process to ensure that this matching remains effective with time.

In this invention, the process involves the injection, at the front end of the sub-array receiver system, an expanded RF pulse which is passed through the receivers and is digitally sampled. The received pulse is compared in the frequency domain with the required response and a set of correction weights are computed. These weights are then digitally applied to all received signals.

In FIG. 1, there is shown the process of the preferred embodiment of the invention. A phased array antenna 10 is communicatively connected to a receiver path 20, that is to say the path from the receiving antenna through any analogue signal processing, where digitisation occurs. The phased array antenna 10, as an alternative, can be any array type transmitter/receiver arrangement using phased on adaptive arrays, mobile communications antenna and the like.

The digitised signal is then communicated from the receiver path 20 to an equalisation module 30 to be corrected for any corruption of the pure received RF pulse that is induced by passing the signal through the receiver path 20. This module is where the comparison of the known waveform and the reference waveform is carried out to produce the correction waveform which is subsequently applied to the data passing through the system that is corrected.

After passing through the equalisation module 30, the corrected data is sent to pulse compression module 40, which is a common signal processing function that is well known by skilled persons and will not be described in detail here.

Once the data has been output from the pulse compression module 40, it is supplied to any signal processing software 50 that is used to process the information gathered from the antenna array.

There are two modes of operation—the calibration phase and the operation phase.

In the calibration phase, the receiver array of the radar to be calibrated is fed with a known swept waveform which covers the full bandwidth of the radar's 10 transmitted pulses across all frequencies. The design of the swept pulse is chosen to provide enough resolution across the frequency range in the correction data, to enable it to be applied to any of the systems specified sampling rates. This allows for the correction data calculated during the calibration stage to be mathematically manipulated via decimation or interpolation, if required, and then to be re-applied to the operational data at any of the systems sampling rates in real time. Hence this covers the full bandwidth of the system during normal operation. The radar passes the output x of this known waveform to the receiver path 20, where it is digitised. At this point the known waveform has passed through the RF and analogue sections of the antenna array. The characteristic of these paths is then captured in the waveform in the form and can be detected by the computations in the calibration process. As these characteristics can differ over the frequency range, a full picture of the response of the system is determined and output to the equalisation module 30. The equalisation module 30 compares the digitised output of the receiver array with a copy of the known waveform which was injected at the start of the process. This information is used to compute a correction waveform for use during the correction phase:

$$\frac{Reference waveform}{Input waveform} = Correction waveform$$

The calibration phase is carried out on start-up of the radar apparatus, then at increasing time intervals of, for example, 5 minutes then 30 minutes then every 2 hours after to allow for the radar apparatus to reach operational temperatures and received radar data to remain optimally corrected during this period. Calibration is required over the thermal range of the system as this can have a significant impact on the characteristic of the RF and analogue signal paths through the array prior to the data being digitised.

In the operation phase, the antenna array 10 receives the radar returns as normal, transmits these to the receiver path 20, which digitises the radar returns and passes them onto the equalisation module 30. The correction waveform as determined in the calibration phase is applied to the digitised radar return, which is then passed on to the pulse compression module 40 and then, in turn, to the radar software 50 for processing.

Referring now to FIG. 2, the preferred embodiment of the invention converts the radar return from the time domain to the frequency domain to enable the radar return to be processed more easily, this is not strictly necessary however simplifies the implementation of the equalisation process in hardware terms. The radar return is converted from the time domain to the frequency domain using a fast Fourier transform 200 before being passed to the equalisation module 210 where either the calibration or operation phase described above is carried out. Once the signal has been corrected in the operation phase, it is passed to the pulse compression module and other saturation processing functions while still in the frequency domain before being converted back to the time domain by an inverse fast Fourier transform 230 and then passed to the radar software 240.

It should be noted by the skilled person that it is not necessary to convert the radar return into the frequency domain, as the processing can be implemented in hardware or software in either the frequency or time domain as necessary.

The method employed in the preferred embodiment described herein is relatively cost-effective with respect to the physical hardware requirements, such as the area required on a hardware board, for example. It will be appreciated by the skilled reader that the principles of the invention above could be implemented all or partly using software.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of receiver equalisation comprising the steps of:
passing a known RF pulse through a receiver array of an antenna;
comparing an output of the receiver array with a reference output of the array; and
calculating a correction waveform to be applied to the output of the array.

2. A method according to claim 1 wherein the known swept RF waveform covering the operational bandwidth of the array antenna is utilised.

3. A method according to claim 1, wherein the output of the receiver array is digitised before being compared to the reference output of the receiver array.

4. A method according to claim 1, wherein the output of the receiver array is fast Fourier transformed into the frequency domain before being compared to the reference output of the receiver array.

5. (canceled)

6. (canceled)
